(19) United States
(12) Patent Application Publication
(10) Pub. No.: US 2006/0058091 A1
(43) Pub. Date: Mar. 16, 2006

(54) Queuing system and method for electronic card table system

(75) Inventors: James T. Crawford III, Charlotte, NC (US); Gehrig Henderson White, Charlotte, NC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: PokerTek, Inc., Matthew, NC (US)

(21) Appl. No.: 11/052,131

(22) Filed: Feb. 7, 2005

Related U.S. Application Data
(63) Continuation-in-part of application No. 10/939,772, filed on Sep. 13, 2004.
(60) Provisional application No. 60/610,262, filed on Sep. 16, 2004.

(51) Int. Cl. A63F 13/00; A63F 9/24

(52) U.S. Cl. 463/13

(57) ABSTRACT

A queuing system and method are provided for filling vacancies at electronic card tables in a card room by establishing electronic waiting lists. The queuing system comprises a plurality of electronic player interaction areas (EPIAs), a queue interface, and a server computer networked to the EPIAs and the queue interface. In use, new players are placed on one or more of the electronic waiting lists, while the EPIAs are monitored for vacancies. Upon detecting a vacant EPIA, the server computer automatically assigns the next new player on the corresponding waiting list to the vacant EPIA.

### RELATED APPLICATIONS

The present application is a continuation-in-part of U.S. patent application Ser. No. 10/939,772, filed Sep. 13, 2004, and claims priority to U.S. Provisional Patent Application Ser. No. 60/610,262 filed on Sep. 15, 2004, both of which are incorporated herein by reference.

### FIELD OF THE INVENTION

The present invention generally relates to a system and method for filling a vacancy at a gaming table. More specifically, the present invention relates to a system and method for establishing an electronic waiting list for new players interested in playing at an electronic poker table.

### BACKGROUND OF THE INVENTION

Gaming is an increasingly popular form of entertainment. Games, particularly games of chance and skill in which one or more players play and place wagers on the outcome thereof may be played in a variety of ways, including at a casino or other venue. Of the various forms of games which are available for play, many are played with playing cards. Of these, poker is arguably the most popular.

Traditionally, poker is played in a poker room in which a plurality of players are seated at a plurality of poker tables with the players wagering paper, coin money or chips on a series of playing cards dealt from a deck of fifty-two cards. Given the significant interest in playing poker, many poker rooms are consistently at capacity. To efficiently seat new players at the poker tables, the casino or venue often employs a queuing system to establish a waiting list of new players to fill vacant seats at the poker tables.

An example of a queuing system is available from QueueOS, LLC™. A typical queuing system establishes an electronic waiting list. In use, a new player, either acting at an electronic kiosk or through a human host, places their name on the electronic waiting list. Once their name is on the electronic waiting list, another casino employee visually monitors the seats at the poker tables. Once a vacancy is found, the human host is notified of the vacancy, and the human host assigns the next new player listed on the electronic waiting list to the vacancy. Once the next new player is assigned to the vacancy, the next new player is alerted of the vacancy and offered the vacant seat.

Unfortunately, the host or other casino employees must continuously monitor the seats in order to ensure that a recently vacated seat will be detected in a short period of time. Otherwise, vacant seats may go unnoticed for several minutes or even hours, thus reducing the total gaming that occurs at those seats. As a result, there is a need in the art for a system that is capable of automatically detecting and assigning the vacant seat to a new player immediately upon the seat becoming vacant.

The present invention is aimed at one or more of the problems set forth above.

### BRIEF SUMMARY OF THE INVENTION AND ADVANTAGES

A system is provided for filling a vacancy at an electronic gaming table with a first new player by establishing an electronic waiting list. The system comprises a plurality of electronic player interaction areas for use by a plurality of players at a plurality of gaming tables. The system also comprises a queue interface which is used to place the first new player on the electronic waiting list. A server computer is networked to the plurality of electronic player interaction areas and the queue interface to provide a network. The server computer is programmed to monitor the plurality of electronic player interaction areas, detect a vacant electronic player interaction area, and automatically assign the first new player to the vacant electronic player interaction area in response to detecting the vacant electronic player interaction area.

A method of filling the vacancy is also provided. The method begins by placing the first new player on the electronic waiting list. The plurality of electronic player interaction areas are monitored at a plurality of electronic gaming tables to determine when one of the plurality of electronic player interaction areas becomes vacant. Thus, the method includes detecting the vacancy of one of the plurality of electronic player interaction areas. Finally, in response to detecting the vacancy, the first new player is automatically assigned to the vacant electronic player interaction area.

The use of the electronic player interaction areas and queue interface networked to the server computer provides instantaneous detection of the vacancy and assignment of the first new player to the vacancy. Furthermore, by utilizing an electronic system, the steps of monitoring, detecting, and assigning are carried out electronically and, thus, automatically, and do not rely on the schedules of a human host or other casino employees.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a diagrammatic illustration of a system for providing an electronic poker game on one or more electronic poker tables, according to an embodiment of the present invention;

FIG. 2 is a simplified diagram of a table top of the electronic poker tables of FIG. 1, according to an embodiment of the present invention;

FIG. 3 is a simplified diagram of a table top of the electronic poker tables of FIG. 1, according to another embodiment of the present invention;

FIG. 4 is a block diagram of the system of FIG. 1, according to an embodiment of the present invention;

FIG. 5 is a second block diagram of the system of FIG. 1, including the element of an electronic poker table, according to an embodiment of the present invention;

FIG. 6 is a diagrammatic illustration of an electronic poker table, according to an embodiment of the present invention;

FIG. 7 is a top view of the electronic poker table of FIG. 6;

FIG. 8 is a diagrammatic illustration of a module of the electronic poker table of FIG. 6, according to an embodiment of the preset invention;

FIG. 9 is a representation of a first screen shot displayed on an electronic player interaction area of the system of FIG. 1, according to an embodiment of the present invention;

FIG. 10 is a representation of a second screen shot displayed on an electronic player interaction area of the system of FIG. 1, according to an embodiment of the present invention;

FIG. 11 is a representation of an electronic player interaction area of the system of FIG. 1 embodied in a hand-held device;

FIG. 12 is a representation of a front side and a back side of an electronic playing card;

FIG. 13A is a block diagram of software components of the system of the present invention;

FIG. 13B is a simplified block diagram of a system for providing an electronic poker game, according to an embodiment of the present invention;

FIG. 14A is a block diagram of a queuing system of the present invention;

FIG. 14B is a second block diagram of the queuing system of FIG. 14A;

FIG. 14C is a perspective view of a poker room equipped with the queuing system of the present invention;

FIG. 14D is a block diagram of a method of filling a vacancy at a gaming table according to one embodiment of the present invention;

FIG. 14E is a second block diagram of the method of FIG. 14D;

FIG. 14F is a representation of a first screen shot displayed on a queue interface of the queuing system; and

FIG. 14G is a representation of a display of the queuing system.

### DETAILED DESCRIPTION OF INVENTION

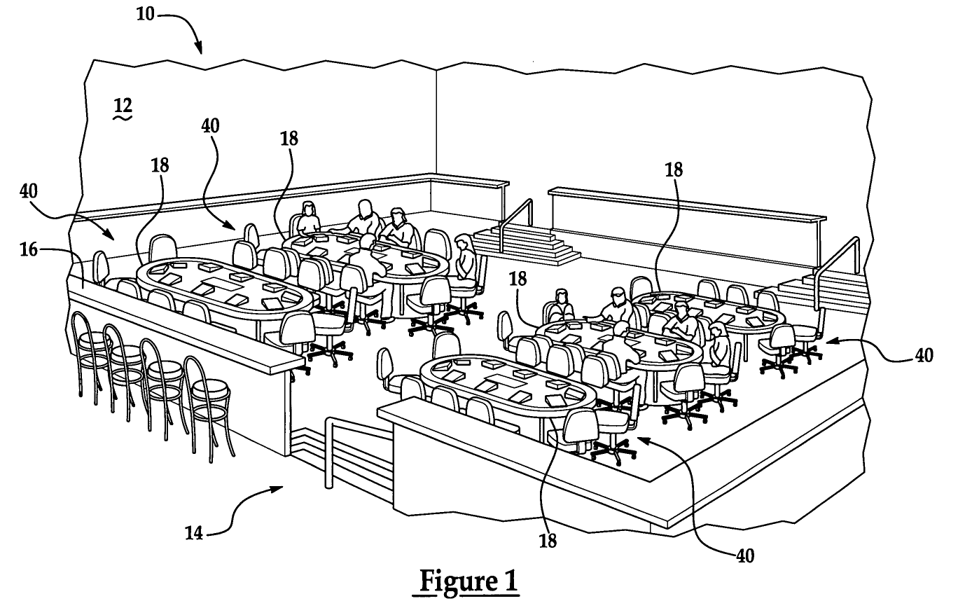

With reference to the drawings and in operation, the present invention relates generally to a system 10 and method for providing, and being related to an electronic card game, such as electronic poker. With specific reference to FIG. 1, the system 10 is designed to be situated in a gaming environment, such as a casino 12. Typically, such gaming environments 12 are a specialized or designated area within the casino 12, such as a poker room or poker area 14, which has been cordoned off by, for example, a railing 16. While the above refers to one possible implementation or location in which the system 10 may be used, the present invention is not limited to any such location or implementation. Other details of the system may be found in U.S. patent application Ser. Nos. N/A (File No. 60,667-007), N/A (File No. 60,667-008), N/A (File No. 60,667-009), N/A (File No. 60,667-010), N/A (File No. 60,667-011), N/A (File No. 60,667-012), N/A (File No. 60,667-013), N/A (File No. 60,667-014), N/A (File No. 60,667-015), N/A (File No. 60,667-016), N/A (File No. 60,667-018), N/A (File No. 60,667-019), N/A (File No. 60,667-020), N/A (File No. 60,667-021), N/A (File No. 60,667-022), N/A (File No. 60,667-023), N/A (File No. 60,667-024), N/A (File No. 60,667-025), N/A (File No. 60,667-026), N/A (File No. 60,667-027), N/A (File No. 60,667-028), N/A (File No. 60,667-029), N/A (File No. 60,667-030), N/A (File No. 60,667-031) and N/A (File No. 60,667-032), which are herein incorporated by reference.

In the illustrated embodiment, the system 10 utilizes electronic chips and electronic playing cards to provide an automated card game for play by two or more players. In one aspect of the present invention, a human dealer is not required. The system 10 may handle all dealer functions.

The system 10 may be used to play any variation or version of any card game. However, for the purposes of discussion, the system 10 will be described as adapted for use in implementing the version of poker known as, Texas Hold'em.

In one aspect of the present invention, the system 10 may handle assigning players to a seat, providing electronic chips, accepting wagers, and assigning a pot to the winning player. The system 10 electronically shuffles a set of electronic playing cards and deals the electronic playing cards to the player and any common cards to an electronic card or poker table 18. The system 10 may also handle wagering, folding, calling by the players and may restrict such, based on whose turn it is.

In another aspect of the present invention, the card or poker tables 18 in the system 10 are networked and connected to one or more servers (see below). The server may be used to implement and facilitate, player tracking, ticket in ticket out (cashless) wagering, assigning player's to a seat at a particular table, tournament play, table set-up (including turning the tables on and off and modifying table parameters), and progressive jackpots.

As shown in the illustrated embodiment, the system 10 includes a plurality of electronic poker tables 18. In the embodiment shown in FIG. 1, the system 10 includes five electronic poker tables 18, although the present invention is not limited to a specific number of electronic poker tables

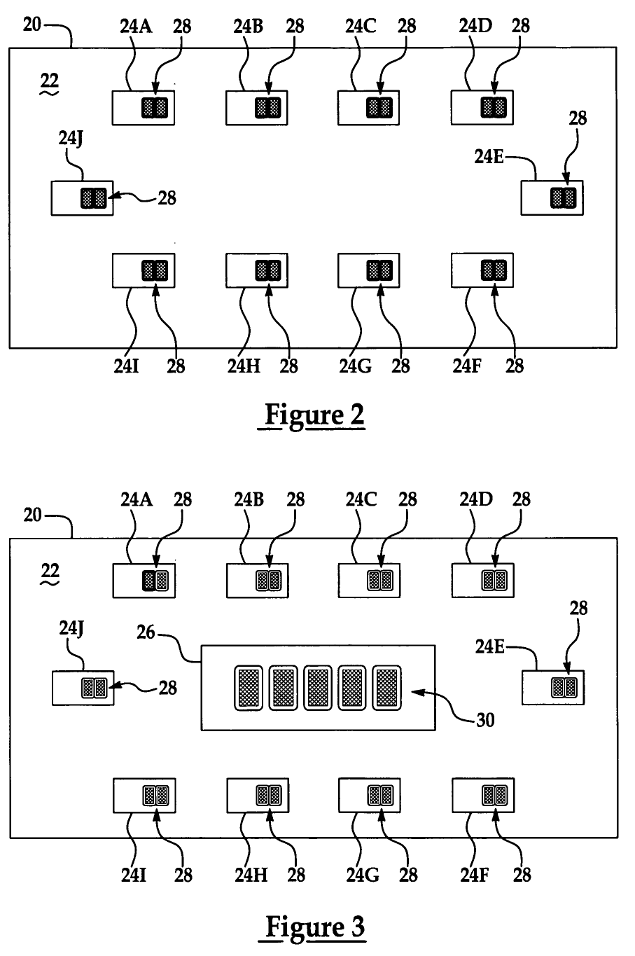

A simple representative layout of a table top 20 of the poker tables 18, according to first and second embodiments of the present invention are shown in FIGS. 2 and 3, respectively.

In the top view of the table top 20 shown in FIG. 2, the table top 20 includes a playing surface 22 and a plurality of electronic player interaction areas (EPIAs) 24. In the illustrated embodiment, the poker tables 18 are able to seat a maximum of ten players at a time, and thus, includes ten EPIAs 24A-24J.

In the top view of the table top 20 shown in FIG. 3 (in which like elements are labeled with the same reference numbers), the table top 20 includes a playing surface 22 and a plurality of EPIAs 24. In the illustrated embodiment, the poker tables 18 are able to seat a maximum of ten players at a time, and thus, includes ten EPIAs 24A-24J. The table top 10 also includes a central or common display area (CDA) 26.

In one embodiment, the individual EPIAs 24A-24J are used to convey game information directly to a player assigned to a specific player interaction area 24A-24J and to implement a player user interface (see below) to effectuate interaction or input from the player. The central or common display area 26 is used to display information to all of the players.

For example in one embodiment, the system 10 is used to play the version of poker known as Texas Hold'em. In Texas Hold'em, each player is dealt a number of cards, e.g., two cards, face down. These are known as a player's “hole” cards 28. A number of cards, e.g., three or five, are dealt face-up and displayed in the common display area 26. These are known as the common cards 30. A player's hand, thus, includes the player's hole cards 28 and the common cards 30. At the end of each hand, of the remaining players, whichever player's hand makes the highest poker hand is the winner of that round or hand of poker.

In one aspect of the present invention, the hole cards 28 are displayed face-down on the respective EPIA 24 and the common cards are displayed in the central display area 26. The hole cards 28 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

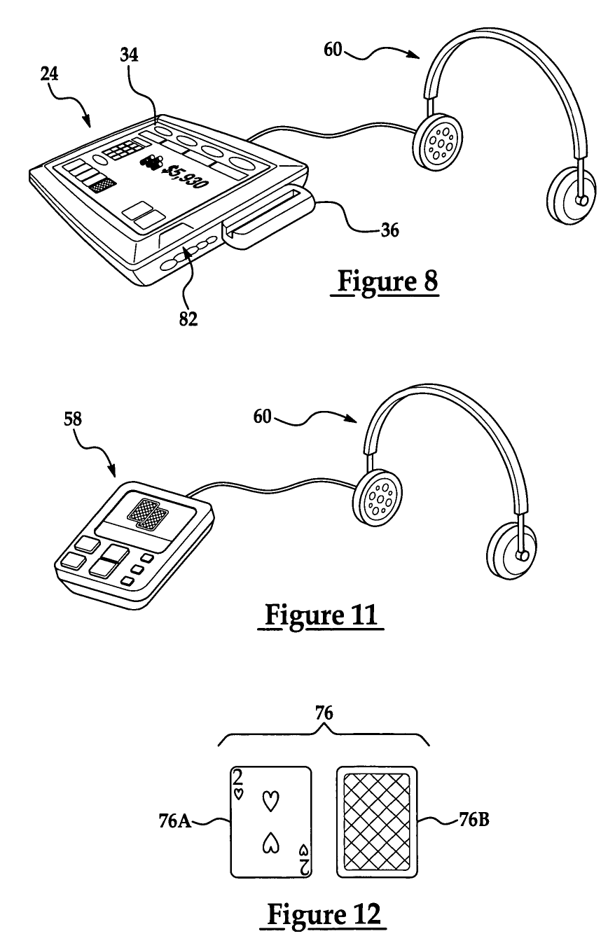

With reference to FIGS. 6, 7, and 8 in one embodiment, the EPIAs 24 are implemented using separate display devices, such as touchscreen displays 32. Each display 32 may be housed in a removable module 34.

The module 34 may incorporate a fully-functional computer. The computer includes a processor capable of running an operating system, such as Windows XP or Windows CE, both available from Microsoft Corporation of Redmond, Wash. In one embodiment, the module 34 includes a card reader 36 for reading a player ID card (not shown).

In the illustrated embodiment, the modules 34 are mounted into the table top 20, such that the touchscreen display 32 is parallel to the table top 20. However, the touchscreen display 32 may be mounted at an angle with respect to the table top 20. Alternatively, the modules 34 may be adjustable to provide a adjustable viewing angle of the touchscreen display 32.

In one embodiment, the central display area 26 is implemented in a separate display, such as a LCD or plasma monitor or similar device.

The remainder of the table top may be covered in a material such as felt, or more specifically, green, blue, or red felt. Logos, game information, or other information may be printed on the material.

In an alternative embodiment, the EPIAs 24 and the central display area 26 may be implemented in a single display which covers a large portion of the table top. The EPIAs 24 and the central display area 26 may be set apart from the rest of the table top 20 by virtual borders. The areas of the display around the EPIAs 24 and the central display area 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20 and/or the electronic player interaction areas 24.

As discussed below, the system 10 and poker tables 18, although electronic, are designed to convey and retain the overall sense and ambience of a standard poker room with non-electrical poker tables. Each electronic poker table 18 is surrounded by a number of poker chairs 40. The number of poker chairs 40 being equal to the number of EPIAs 24 on the electronic poker table 18.

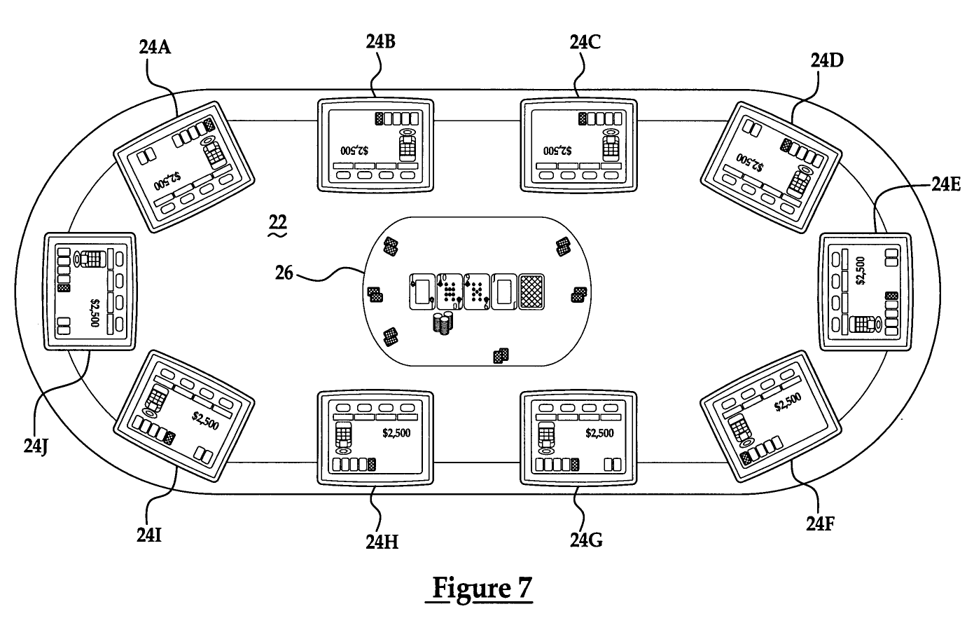

With particular reference to FIGS. 6 and 7, in the illustrated embodiment the poker tables 18 have an oval shape and may seat a maximum number of players. For example, the poker tables 18 may be sized to seat a maximum of 7, 8, 9, 10, or 11 players, although the present invention is not limited to any particular sized poker table. As stated above the table top is covered, in between the EPIA, and the central or common display area if provided, by material, such as green felt, or simulation thereof. The poker table includes one or more bases 42 to which one or more legs 44 are connected. The legs 44 support the table top. A rail or bumper 46 encircles the outer circumference of the table top 20.

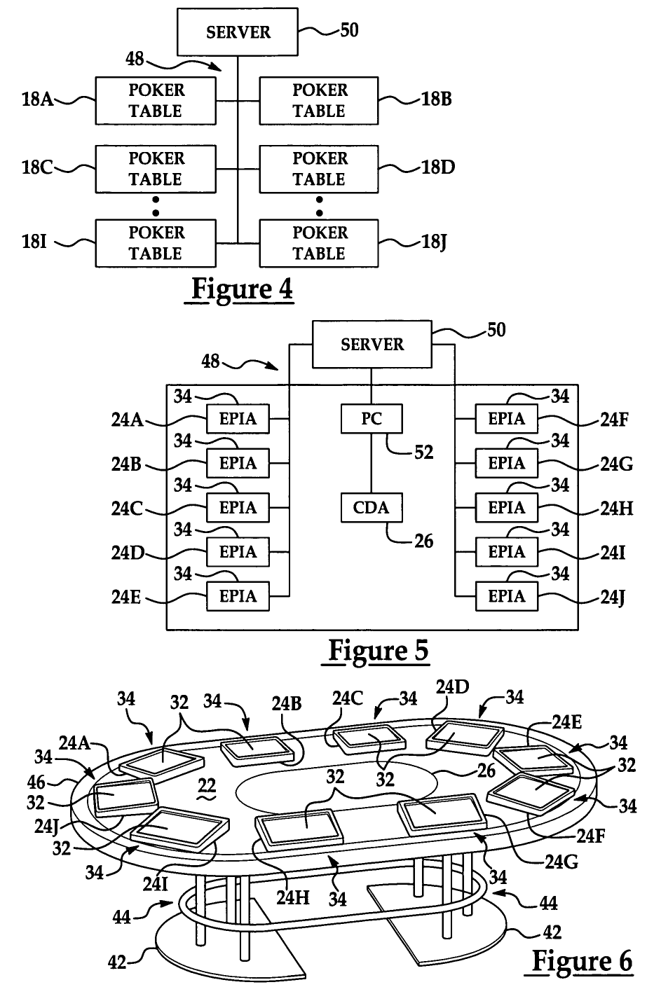

With specific reference to FIGS. 4 and 5, as discussed above the system 10 may include one or more electronic poker tables 18. In one aspect of the present invention, the poker tables 18 are networked together using, e.g., an Ethernet network 48. One or more servers 50 may be used to provide functionality for the system 10. For example, the server 50 may be used to implement various functions, including, but not limited to:
starting and stopping the tables 18 on a game,
data and player tracking,
cashless wagering,
defining and modifying table parameters, including, turning the tables 18 on and off, setting the poker game being played at the table 18, setting wager parameters, etc. . . . ,
defining and managing jackpots, including the house percentage, i.e., the rake,
defining and managing progressive jackpots,
establishing and managing an electronic waiting list for players and assigning players to seats and/or specific tables from the electronic waiting list, and
establishing and managing tournament play, including assigning player seats, collapsing tables, etc. . . . .

With particular reference to FIG. 5, in one embodiment each table 18 includes ten EPIAs 24A-24J, which are implemented in a computer based module 34. Each module 34 operates or runs on an operating system, such as Microsoft Windows XP or Windows CE. Each module 34 is connected to the server 50 through the network 48. As shown, another computer 52, such as a personal computer running on Windows XP, may also be connected to the server 50 through the network 48. The primary function of the PC 52 may be to control and drive the central display area 26.

In one embodiment, the server 50 runs the poker games on each of the tables 18. The primary function of the modules 34 is to run the EPIAs 34, to display and run a user interface.

In another embodiment, the poker game or portions of the poker game may be executed or run by the modules 34 and/or the computer 52.

In another aspect of the present invention, the system 10 will implement a player-account based cash in/cash out system. The system 10 will create a user account for each player. Once an account is established for the player, the player is issued a Player Card having an associated personal identification number or PIN. Once the player has been issued a Player Card, their account may be funded. The Player Card is used to identify the player at the tables 18. The player may fund their account by bringing cash to a cage, where the cash is accepted and credited to the player's account. Printed receipts are given to the player and maintained by the casino 12. To bring electronic chips to the table 18, the player sits down at a seat, swipes their Player Card and enters their PIN. The system 10 informs the player of their account balance and allows them to convert all or a portion of the account balance to electronic chips to bring to the game.

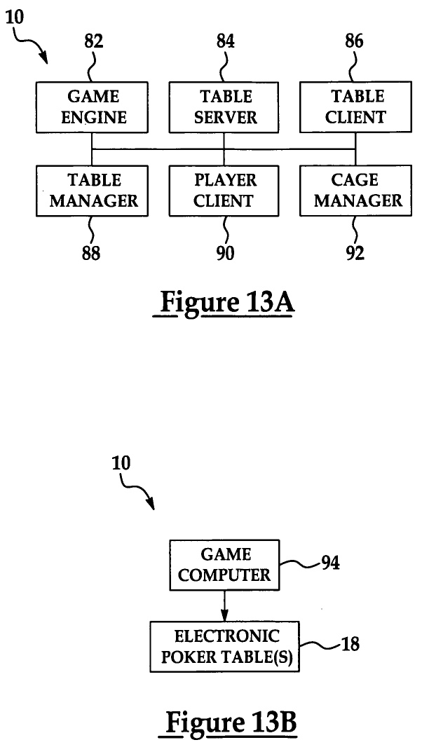

With particular reference to FIG. 13A, from a software perspective the system 10 may be implemented using six program groups: a game engine 82, a table server 84, a table client 86, a player client 88, a table manager 90, and a cage manager 92. The table server 84 implements the network communication, control and authentication as well as inter-table functions (seat reservations, multi-table tournaments). The game engine 82 administers the electronic poker game and is responsible for all game functions, e.g., electronic playing card deck generation, dealing, betting, determining winners and awarding pots. The table client 86 is the graphical control for the central data area 26. The player client 90 implements the user interface for the EPIAs 24 and the logic for capturing player input and communication the player input to the table client server. The table manager 88 contains the user interface for setting user, network, and game parameters, for starting, pausing, and stopping games, and for monitoring game activity and responding to system or user generated alerts. The cage manager 92 provides the ability to create and fund player accounts and to create the Player Cards.

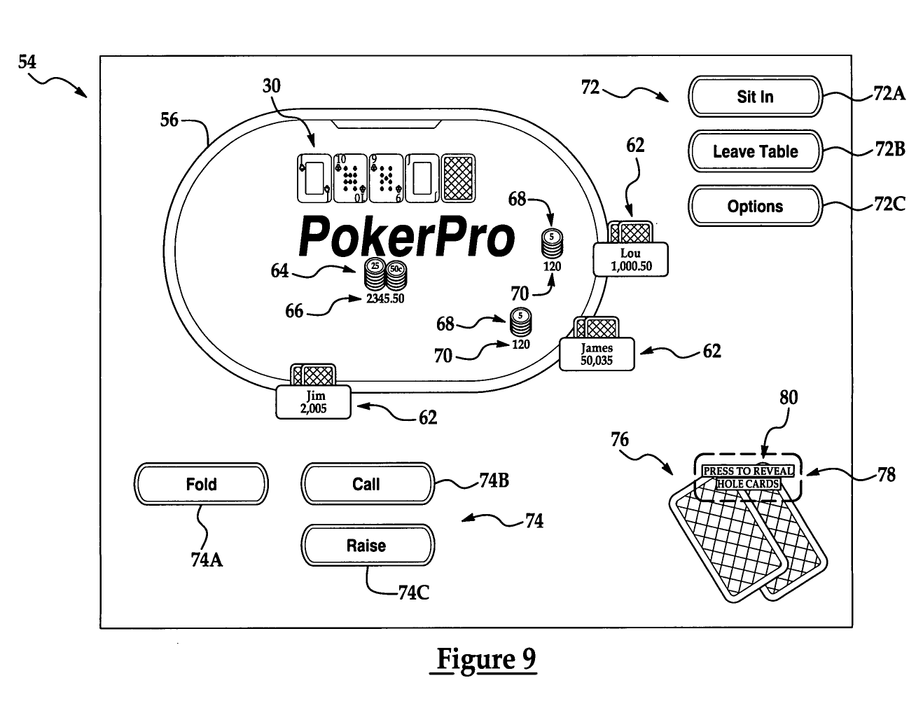

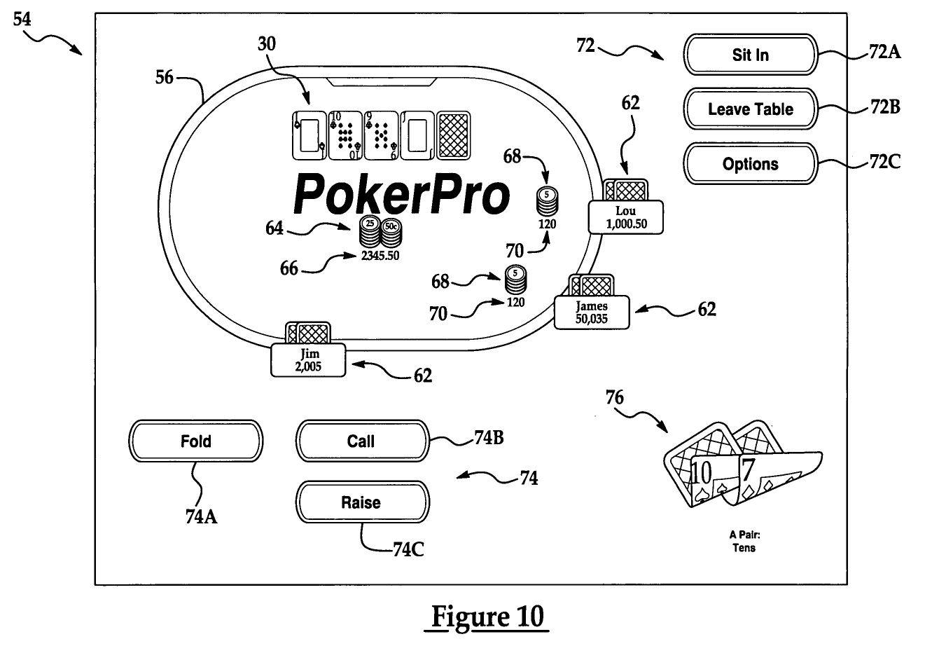

With reference to FIGS. 9 and 10, each EPIA 24 implements a player interface 54. The player interfaces 54 may be implemented on the table top 20 (see above), or in the module 34. In another embodiment, the player interface 54 may be implemented on a hand-held device 58, such as a personal data assistant (PDA).

The player interface 52 may be graphical in nature (as shown in FIGS. 9 and 10), or may take other forms, such as a simple textual format. In one embodiment the EPIAs 24 provide the player with the option of choosing between several player interfaces 52, such as a graphical representational of an electronic poker table 56 or the text interface.

Returning to FIGS. 9 and 10, in one embodiment the player interface 54 includes a graphical representation of a poker table 56. Each player in the poker game may be represented by a user graphic or icon 62, which may list their names as well as their chip totals. The pot of the current hand may be represented in the center of the poker table 56 by stack(s) of chips 64 and/or a number 66 representing the value of the current pot. Each player's contribution to the pot may be represented by stack(s) of chips 68 and/or a number 70 adjacent their user graphic 62.

The player interface 54 may also includes a series of player option buttons 72 and a series of game buttons 74. The player option buttons 72 may include, for example, a sit in button 72A, a leave table button 72B, and an options button 72C. Generally, only one of the sit in button 72A and the leave table button 72B would be active at any time. The options button 72C allows the player to access an option menu or screen (not shown) which allow the player to modify certain parameters of the player interface 54, such as, for example, to choose between different formats of the player interface 54. The series of game buttons 74 allow the player to signal their game play decisions to the system 10 during the play of the game. The game buttons 74 may include a fold button 74A, a call button 74B and a raise button 74C. These typically would only be active when it is a player's turn in the poker game. In one embodiment, the buttons 72 are implemented on the touch screen display devices 32. In an alternative embodiment, the buttons 72 are embodied in electromechanical switches or buttons (not shown).

In one embodiment, the player interface 34 may also include the community cards 30. Other information which may be displayed on the player interface include, but is not limited to indicator of the player whose turn it is, a total of chips for each player, any cards of the other players which are face-up, and/or messages to the player, such as advertising.

In another aspect of the present invention, the player interface 54 includes a graphical representation of one or more of electronic playing cards 76 (see FIG. 12). Each electronic playing card 76 has a front side 76A and a back side 76B. The back side 76B of each card has an identical pattern or image such that the cards cannot be told apart when viewing the back side 76B. The electronic playing card 76 is typically one of a set or deck of standard playing cards. The deck may be a standard deck of 52 cards, each card having a value. The value being two components: the first component being one of a two through ACE and the second component being one of four suits (hearts, diamonds, clubs, spades). The value of each card is indicated on the front side 76A of each playing card 76.

The image displayed on the back side 76B of the playing cards may be a logo, a random image (chosen from a set of predetermined images), or may be advertising directed at the player. The image may include a video. In one embodiment, the image displayed on the back side 76B of the playing cards may be cycled through a set of predetermined images. The image may be selectable by a user, who may be the player or an employee of the casino.

In one embodiment, the electronic playing card or cards 76 are a player's hole card(s) in an electronic poker game. However, the electronic playing 76 cards may be used in any sort of electronic card game in which it is desirable to controllably display/hide the player's cards. Thus, while the present invention may be described below in the context of an electronic poker game (and more specifically, with respect to a player's hole cards in a Hold'em style poker game), the present invention is not limited to such a card game.

In a playing card game with physical cards, in which the player's card are dealt “face-down” and not revealed to any other player, the player may look at their cards, while attempting to keep the cards secret from the other players in several ways. For example, the player may lift the cards close to their bodies, spread them out, and shield them with their hands, so only the player can see the front side of their cards. Or the player may leave the cards face down on the table and lift one side or corner revealing at least a portion of the front side, while shielding the cards with their hands.

A controller, which is either, the module 34, the personal computer 52, the hand-held device 58, the server 50 or a combination thereof, controls the player interface 54, i.e., controls the information components of the player interface 54 displayed on the EPIAs 24, detects touches on the touch screen display devices 32 (when utilized) and interprets the touches as trigger or touch events (see below). As discussed below, the controller 24, 52, 58, 50 may control the display or obscuring (hiding) of the player's hole electronic playing card(s) such that the player may controllably display and view the cards, while maintaining them secret from the other players. As if the player was playing with physical playing cards, the player, thus, has the opportunity to shield their cards with their hand or hands prior to them being revealed.

A system and method for controllable displaying/obscuring the player's hole electronic playing card(s) is disclosed in U.S. patent application Ser. No. 10/939,772, filed Sep. 13, 2004, which is hereby incorporated by reference.

In one aspect of the present invention, each EPIA 24 is assigned to a player. Once the player is assigned is to a particular seat at a table 18, the associated EPIA 24 may set as inactive or locked and may indicate the assigned player's name. Once the EPIA 24 is locked, the assigned player must login to the EPIA 24 (see below).

Once the player log-ins, the EPIA 24 becomes active and the player interface 54 is displayed. Also, since the EPIA 24 is active, the player may enter or sit-in on the game being player at the table 12 or adjust/modify any available options by actuating the options button 72C.

In one embodiment as discussed above, the EPIAs may be implemented using a separate or modular computer 34. In one embodiment, the modular computer 34 includes a display 32 which may be a touch-screen display 34. The touch-screen display displays information (text and/or graphics) regarding the play of the game and implements buttons or selectable areas on the EPIA 24 for user input.

A player may log-in to the system 10 or table 18 through the EPIA 24. In one embodiment, the player may log-in to the system using a player tracking card. The player inserts or swipes their player tracking card through the card reader 36. The EPIA 10 may also require entry of a PIN into an attached keypad or keypad implemented on the touchpad display device 34. Alternatively or in addition, the player may log-in using a biometric parameter, such as a fingerprint, sensed by a sensor and a RFID card or chip.

In one aspect of the present invention, the EPIA 24 includes a sound generation device which is used to generate sounds audible to the player assigned to the EPIA 24. The sound generation device may be implemented as an earpiece or headphones or one or more speakers. Generated sounds may be categorized as system sound or player sounds. System sounds include sounds which are intended or suitable to be heard by everyone, including other players and non-players. Player sounds include sounds which are intended to be heard, but not necessarily only, by the player. Example, system sounds may include sounds imitating the shuffling of cards, the dealing of cards, chips thrown into the pot, sounds related to the winning of the jackpot. Player sounds may include a reminder or indication of a player's turn or if the game is timed, an indication of the time remaining or that time is running out. Player exclusive sounds are sounds that can or should only be heard by the player and may indicate an audible signal indicating the player's hole cards or the highest hand of the player or a winning percentage associated with the player's hand.

In another aspect of the present invention, the EPIAs 24 may be implemented via a touchscreen display device 32. The devices 32 may be integrated with a computer in a module. Alternatively, the touchscreen devices 32 may be separate devices controlled by separate computers or the computer 52 at the table 18 or the server 50.

In many gaming environments 12, such as a poker room at a casino, a portion or percentage of each pot goes to the house for running the poker game. This portion of the pot is known as the rake. In one embodiment, the amount of the rake corresponding to the current pot is displayed on each EPIA 24. The rake may be shown as an amount in dollars and may include a graphical representation of electronic chips.

In one aspect of the present invention, the system 10 utilizes both electronic chips and electronic playing cards. In one embodiment, the EPIA 24 may include a graphical representation of the chips and/or a dollar amount indicative of the amount of chips each player at the table has remaining. Additionally, the EPIA 24 may include a graphical representation of the chips and/or a dollar amount indicative of the amount of the current pot. The pot may be shown in the middle of a graphical representation of the poker table.

In one embodiment, each EPIA 24 may also include a graphical representation of the community cards in the middle of the graphical representation of the poker table. Graphical representations of the other player's card may also be shown (face-down during the current hand and face-up at the end of the hand).

As discussed above, system 10 may require that the player log-ins to the EPIAs 18 which is open or to which they have been assigned. The log-in may be accomplished in a variety of ways (see above). Once a player's identity has been established, however, the player can access a player account, purchase chips using an account balance. Additionally, information regarding the player's play at the table may be tracked and recorded to the player's account.

The EPIAs 18 may be provided with an Ear- or head-phone to provide the sounds (see above) or other signals to the player.

In one aspect of the present invention, the sounds provided by the EPIA 24 (see above), are provided using a simulated voice.

In one aspect of the present invention, the system may utilize a cashless system, such as Ticket-In Ticket-Out or “TITO” (see below)

In one embodiment, the system 10 requires that each player has a player account. The player account may have an associated balance which contains a dollar amount based on an amount of money deposited by the player and/or any winnings that they have collected, either through poker or some other game. Once a player has been identified by the EPIA 24, the player may download a dollar amount and purchase chips to play.

Alternatively, a ticket (with for example a barcode), magnetic card, RFID card, or some other media (jointly referred to as a TICKET) may be inserted in the EPIA 24, the table 18, or at a kiosk. The TICKET may have an associated value which is either printed and/or encoded thereon or which is associated with the TICKET in the system 10.

Additionally, once the player decides to leave the table 18, any remaining chips they have, may be instantly converted back into dollars and stored in their player account and/or a new Ticket may be generated.

In another aspect of the present invention, each EPIA 24 may provide an indication of whose turn it is to act. If it is the player's turn who is assigned to an EPIA 24, then the EPIA 24 may provide an appropriate signal, such as an icon, either next to their name or anywhere on the EPIA 24, a sound such as a beep or musical tones, and/or a voice message. If it is another player's turn, the EPIA 24 may indicate whose turn it is by an icon and/or flashing text, e.g., adjacent the player's turn.

As discussed above, the EPIA 24 includes a set of player option buttons 72 which allow the player to take an appropriate action, such as bet, fold, or call, during their turn. In one embodiment, the EPIA 24 only activates those buttons 72 which are appropriate, given the rules of the game being played, during the current turn. For example, if the maximum number of raises for a particular game have already been made, then the wager or raise button would be inactive. Additionally, all of the buttons 72 will be inactive when it is not the player's turn.

As discussed above, each seat or EPIA 24 is assigned to a particular player. The player may be assigned to a seat off a queue using a queue system or may be assigned by an employee of the casino using the system 10. However, under certain situations, the player may desire to change seats or move to another table. For example, if another player or players have left the table leaving fewer players at the table and the player does not like to play at a table with that few of players, the player may request through the EPIA 24 another seat assignment.

The present invention includes methods for displaying and/or obscuring a player's hole cards (see above). Additionally or separately, the EPIA 24 may be adapted to provide an indication of the winning percentage based on the player's current hand and the community cards. The winning percentage may be shown textually, e.g., 55%, and/or graphically, e.g., a pie-chart or bar chart. The winning percentage may be triggered and shown using the same trigger event associated with the hole cards. Alternatively, a separate trigger event, such as a touch-event on another location on the EPIA 24 may be used to show the winning percentage.

The present invention includes methods for displaying and/or obscuring a player's hole cards (see above). Additionally or separately, the EPIA 24 may be adapted to provide an indication of the player's current highest hand based on the player's current hand and the community cards. The highest hand may be shown textually, e.g., two-pairs, and/or graphically, pictures of the five cards which make of the highest hand. The highest hand may be triggered and shown using the same trigger event associated with the hole cards. Alternatively, a separate trigger event, such as a touch-event on another location on the EPIA 24 may be used to show the highest hand.
1. Utilizing Surface Acoustic Wave touch screen technology
2. Utilizing Multi Touch touch screen technology
3. Player away feature: Allows a player to press a button to temporarily remove himself from the game. Secure process for returning him to game accounting for missed blinds.
4. User customizable views of the game: Allow many views of the game and method to allow user to select preferred view.
5. Integrated with speakers
6. Method to obscure player pre-selection of one or several bet options: Poker is a sequential game. Situations exist where a player will know what action they want to take prior to it being there turn. Allowing the player to make that decision in advance of their turn in a way that allows players seating close to observe this action would provide an unfair advantage to some players and not others. This feature allows a player to make a pre-selection while observing his hole cards in such a way that other players will not be able to observe that pre-selection.
7. Ability to display live and pre-recorded Video
   II. The Poker Table(s)—Generally

As discussed above, a poker table 18 may include one or more EPIAs 24. For example, each poker table may have 11 seats and accommodate up to 11 players. Each EPIA 24 may have one or more of the features described in IV.

In one embodiment as discussed above, the EPIAs may be implemented using a separate or modular computer 34. In one embodiment, the modular computer 34 includes a display 32 which may be a touch-screen display 34. The touch-screen display displays information (text and/or graphics) regarding the play of the game and implements buttons or selectable areas on the EPIA 24 for user input.

In one embodiment, the modular computer 34 includes a display 32 which may be a touch-screen display 34. The touch-screen display displays information (text and/or graphics) regarding the play of the game and implements buttons or selectable areas on the EPIA 24 for user input.

In one aspect of the present invention, the table 18 includes a table sound generation device which is used to generate sounds audible to the players. The table sound generation device may be implemented one or more speakers mounted to integral with the table 18. Alternatively, the table sound generation device may include one or more speakers adjacent to or integral with each EPIA 24. Generally, the sound generation device plays system sounds or player sounds which are suitable for every player to hear.

For example, system sounds may include sounds imitating the shuffling of cards, the dealing of cards, chips thrown into the pot, sounds related to the winning of the jackpot. Player sounds may include a reminder or indication of a player's turn or if the game is timed, an indication of the time remaining or that time is running out. Generally, player exclusive sounds will not be player through the player sound generation device.

In one embodiment of the present invention, the poker table 18 includes a central display area 26. As discussed above, the individual EPIAs 24A-24J are used to convey game information directly to a player assigned to a specific player interaction area 24A-24J and to implement a player user interface to effectuate interaction or input from the player. The central or common display area 26 is used to display information to all of the players.

The common cards 30 are displayed in the central or common display area 26.

In one embodiment, the central display area 26 is implemented in a separate display 38, such as a LCD or plasma monitor or similar device. The remainder of the table top may be covered in a material such as felt, or more specifically, green, blue, or red felt. Logos, game information, or other information may be printed on the material.

As discussed above, the common cards 30 are displayed in a larger size than the hole cards 26 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

In an alternative embodiment, the EPIAs 24 and the central display area 26 may be implemented in a single display which covers a large portion of the table top. The EPIAs 24 and the central display area 26 may be set apart from the rest of the table top 20 by virtual borders. The areas of the display around the EPIAs 24 and the central display area 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20.

Typically displays, such as LCD or Plasma monitors are rectangular in form. As shown in FIGS. 6 and 7, the overlay may be integral with the table top 20 and may include a cut out. The overlay covers the outer edge of the display. Only the portion of the display inside the cut-out is visible. In the illustrated embodiment, the cut out has a shape, such as an oval shape, which is similar to the shape of the table.

As discussed above, the rake is defined as a portion or percentage of each pot that goes to the house for running the poker game. This portion of the pot is known as the rake. In one embodiment, the amount of the rake corresponding to the current pot is displayed on the central display area 26. The rake may be shown as an amount in dollars and may include a graphical representation of electronic chips.

In another aspect of the present invention, the central display area 26 may provide an indication of whose turn it is to act. In one embodiment, the central display area 26 may provide an appropriate signal, such as an icon, e.g., an arrow or other symbol, a sound such as a beep or musical tones, and/or a voice message. This indication of a player's turn may be in addition to the indication on the EPIA 24.

During a poker hand, even at a standard poker table with a human dealer, one of the players is designated as the “dealer”, for the purposes of the order in which the playing cards are dealt and in which wagers are made. In one aspect of the present invention, the central display area 26 may provide an indication of which player is designated the “dealer” for the current hand. In one embodiment, the central display area 26 may provide an appropriate signal, such as an icon, e.g., an arrow or other symbol. This indication of a player's turn may be in addition to the indication on the EPIA 24.

As discussed above, the hole cards 28 are displayed face-down on the respective EPIA 24 and the common cards are displayed in the central display area 26. In one aspect, the common cards 30 are displayed at a larger size than the hole card 28.

In one embodiment, the hole cards 28 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

In one aspect of the present invention, the table 18 provides a poker game, such as Texas Hold'em for the players. In one embodiment, the provided poker game is a timed game, i.e., the player's have a predetermined time period in which to complete each turn. For example, the player's have a set period of one minute to complete each turn. Alternatively, the period of time may vary based, e.g., the first turn may have a period of completion of one minute, while the second turn may have a shorter or longer period of completion. Alternatively, each player may have a bank of time. The time used to complete each turn may be deducted from their time bank.

In another aspect of the present invention, the central display 38 may be used to display advertising messages. The advertising messages may be from the casino or third parties and may consist of graphics, pictures, animations, video and/or audio. The advertising may be presented at specific location on the central display 38 and may be varied, based on time, i.e., cycled through a set of advertising messages.
1. Display and/or animation of blinds on Central Display Area 26
2. Display and/or animation of community cards on Central Display Area 26
3. Display and/or animation of bets placed and player chip stacks on Central Display Area 26
4. Indication of players who have folded and not folded on Central Display Area 26
5. Display and animation of winning hands on Central Display Area 26
6. Central Display Area 26 utilizing transducer sound emitting technology eliminating the need for separate speakers
7. Display on Central Display Area 26 of wining hand percentage estimates in situations where all remaining players cards are exposed e.g. remaining players are all in.

With particular reference to FIG. 13B, in one embodiment the game engine 82 is implemented or run on a game computer 94. If the electronic poker table 18 is a stand-alone table 18, then the electronic poker table 18 may include its own game computer 94. Alternatively, the game computer 94 may be the server 50, which may be networked to multiple electronic poker tables 18.

In one embodiment, the game engine 82 includes a random number generator or RNG (not shown). At the beginning of each hand of the electronic poker game, the RNG is used to shuffle a deck of 52 electronic cards and to determine the deck order. One of the players is designated as the dealer.

If the poker table 18 is playing Texas Hold'em, the player on the dealer's left (typically designated by the dealer button) is known as the “Big Blind” and the player on the left of the Big Blind is known as the “Little Blind”. At the beginning of the hand, the player known as the Big Blind must post into the pot a predetermined amount, e.g., $1, $5, or $10. This amount is also known as the Big Blind. The player known as the Little Blind must also post into the pot a predetermined amount, typically ½ of the Big Blind. This amount is also known as the Little Blind. Typically, the game computer 82 will automatically deduct the Big Blind and the Little Blind from the respective player's stacks and add them to the pot.

After the blinds have been posted, the game computer 82 will deal two cards, i.e., the players' hole cards, face down to each player. These cards are displayed face down on each player's EPIA 24. As described above, each player may controllably view their hole cards.

After the hole cards are dealt, the game computer 82 administers a betting round. The first betting round starts with the player on the left of the Little Blind. Generally, each player is given an appropriate set of selections in the form of the game buttons 74. In one embodiment, the game buttons 74 are displayed only during the player's turn. Furthermore, only the game buttons 74 which, according to the rules of the poker game being played, are appropriate are displayed.

After the first betting round, three community cards, i.e., the “flop” are dealt faceup by the game computer 82 and displayed. In one embodiment, the community cards are displayed in each EPIA 24, as shown. If a central display area 26 is used, then the community cards may alternatively or in addition be displayed thereon.

This is followed by a second betting round. After the second betting round, a fourth community card, i.e. the “turn” is dealt by the game computer 82, followed by a third betting round.

After the third betting round, the fifth and final community card, i.e., the “river” is dealt face up. This is followed by the fourth and final betting round. If more than one player remains after the final betting round, the player with the highest hand is determined as the winner of the hand.

If after any of the first through third betting rounds, only one player remains, then the remaining player is automatically determined as the winner. Since one or more of the community cards have not been dealt, the rabbit button 72D on each EPIA 24 becomes active or is displayed, as described above).

In one aspect of the present invention, the poker tables 18 in the system 10 are networked and connected to one or more servers 50. The server 50 may be used to implement and facilitate, player tracking, ticket in ticket out (cashless) wagering, assigning player's to a seat at a particular table, tournament play, table set-up (including turning the tables on and off and modifying table parameters), and progressive jackpots. Each table 18 may have one or more EPIAs 24. The poker tables 18 and the EPIA may have one or more of the features described in VI.A. and VI.B.

In addition, other devices may be connected to the server 50 for providing additional features and/or functions. For example, a queueing system may be provided (see below). This system may be implemented using a separate computer which implements this function. The separate computer may also implement other features or functions of the system. It should be noted, however, that in some systems, these additional features or function could be provided, at least in part, by the server(s) 50.

In one aspect of the present invention, the server 50 runs the games. In other words, the server 50 electronically “shuffles” the playing cards, deals the cards, controls the players' turns, receives the player's inputs and acts accordingly, tracks, manages, and awards the pot, tracks the rake, etc. Game data is stored in a database. Each input, wager, play, etc., is stored in the database.

In one aspect of the present invention, the server 50 provides an interface which allows a user, such as an authorized or designated employee of the casino, to set-up a new table 18 or to modify the parameters of an existing table 18. The interface may be implemented on a server 50 or on another device networked to the server 50.

The interface may provide one or more of the following features: ability to turn a table on/off, and ability to change game parameters, such as the permitted wagers, the game being players, the rake, etc.

In one aspect of the present invention, as stated above the system 10 tracks each transaction, wager, card dealt in a database. The system 10 also tracks the players which are playing at each table 10. This information is stored in the database, summarized, and may be presented in any numerous forms of reporting formats. Any information regarding the player's, the games, and how each hand is played may be tracked. This available data may also be analyzed for purposes of determining the frequency of poker hands (per hour) for a table or all games in which a particular player or players played or detecting, e.g., collusion between players.

As discussed above, in one embodiment every player must belong to a player club and have an assigned player ID card to log-in to an EPIA 24 to player poker at a table 18. Each player has an account in the player tracking club. The player's account in the tracking club tracks the amount of cash or money that the player has available for play at poker. The player's account also tracks the player's play at a poker table 18, including amounts wagered and amounts won.

The system 10 allows jackpots, i.e., progressive jackpots, to be generated by and won across multiple hands and/or multiple tables. A progressive jackpot may increase based on the amounts wagered and/or won at the included tables. The progressive jackpot may continue to increase until won under a set of predetermined conditions. Alternatively, it may be active until only for a predetermined time period. The conditions for winning the jackpot that it is won by one or more players at the end of the time period.

The system 10 allows a progressive jackpot to be funded in multiple ways. The way in which a progressive jackpot is funded may be funded through a computer program application on the server 50 or other device. For example, the progressive jackpot may be funded by taking a set percentage from every pot, every other pot, or every n^{th} pot.

The amount of the progressive jackpot may be displayed on the central display 38 and/or a remote display.

The progressive jackpot may be initiated randomly, under certain defineable conditions, and/or for a specific event, i.e., a marketing event. The progressive jackpot may be a single hand (across multiple hands), a predetermined number of hands at one table or across multiple hands, for a predetermined time period, etc.
8. Progressive, side-bet, Double-Up, Mystery and many other jackpot techniques are well understood in relation to slot machines. Methods and systems to apply those techniques in combination with an automated poker table.
9. Displaying Gov't Reporting Form in EPIA

In another aspect of the present invention, after a jackpot is won by a player or the player logs out or any winner exceeds a predetermined amount, or at any other appropriate time, one or more government reporting forms may be presented to the player on their EPIA 24. The form may accept the player's electronic signature (if permissible) or may notify the player of the requirements and direct them to a location where they can fill out the form. The device may be a personal, notebook, or tablet computer, handheld computer, PDA, or other suitable device.

In one aspect of the present invention, one or more employees of the casino may be assigned to manage a plurality of tables. One of the employees may manage the queueing system (where provided). A device, networked to the server, may be provided which provides various functions to the employees. The device provides a dashboard application which allows the employee to manage various aspect of the tables 18

In one aspect of the present invention, the employee may view various data related to the current state of a table, including, but not limited to, the players, the pot, wager information, the common cards, etc.

The employee, for example, in response to an in-person query or a quiry made through an EPIA 24, may view tracked data to look for evidence of collusion between two or more players. For example, the employee may determine if two or more persons at a particular table have a habit of playing at the same time and to determine if there is any pattern discernable in the play which would provide evidence that they are impermissibly working together.

In one aspect of the present invention, each EPIA 24 may provide a player with buttons which summon or direct specific employees of the casino. For example the player may request a host/hostess to order a drink. Additionally, the player may request that an employee review something that occurred or is occurring at the table 18, e.g., possible collusion. This may be done anonymously.

As described above, the device which allows the players to manage the tables 18, may also allow the employee to automatically or manually assign players to particular tables and/or seats and/or EPIA 24.

In one embodiment, the server 50 controls the advertising on the central display 38. Advertising may also be provided on the EPIA's 24 and/or a remote display associated with the poker tables 18. The server 50 may control the content, frequency, and/or the cycling of the advertising.

In one aspect of the present invention, a player may refrain from playing in one or more hands or get up from a table and not play in one or more hands. Typically, however, if the player decides to play a subsequent hand, than the player owes the current pot a predetermined amount, i.e., the “missed blind”, per hand missed. In one embodiment, if the player decides to sit-out one or more hands, then the system 10 tracks the number of hands missed and automatically deducts an amount equal to the number of hands missed multiplied by the blind once the player decides to play another hand.

As discussed above, the system 10 records every transaction, card dealt or played, wager, etc. . . . in a database. This allows the system 10 to recover from any error and put the game back into the same state.

The system 10 facilitates tournament play. In a tournament, a predetermined number of tables 18 having a predetermined number of players are involved. A buy-in, e.g., $100 is required. Typically, after a player loses all of their money, they are eliminated from the tournament.

Under predetermined rules, players may register for a tournament and be assigned to seats at a table. During play, under predetermined rules, tables may be broken down and the players distributed to other tables. The system 10 facilitates the tournament by providing one or more of the following features:
a) Registration
b) Tracking tournament information
c) display of tournament information on central display and/or remote display
d) tournament set-up, e.g., buy-in
e) Re buy-in
f) tournament jackpot, cash or entry voucher for entry another tournament (specific tournament or expiration date)
g) Process for breaking tables
   (1) message that table is breaking
   (2) convey new seat assignment
   (3) determination of breaking order
   (4) display of breaking order
h) display information on status of other tables and players at other tables
i) System to monitor and adjust hands per hour of an individual table during a tournament: During a poker tournament it is important that each table play roughly the same number of hands per hour as all other tables. This can be accomplished by pausing a game and/or slowing a game down with out pausing.
j) Multi-site tournaments.
k) System for automatically paying players tournament winnings based on tournament pay tables and their final position in the tournament.

10. Automatic posting of blinds and method to turn on and off of automatic posting of blinds/missed blinds.

11. Method for automatically calculating allowed bet amounts in pot-limit and no-limit betting structures.

12. Automatic varying of rake based upon number of players, amount of pot, time of day, type of game and/or other criteria.

13. Ability to offer rake discounts to individual players.

14. Transferring a player from one seat to another at the same table, or to another: Situations exist where are forced to (“must move”) or desire to move seats. This feature provides automatic notification and movement of player information from one seat to another.

15. Database and network architecture allowing single and multi-site networking and management of a plurality of automated poker tables.

16. Tracking and reporting of player statistics: Data and method of display over the internet and/or other methods for player to analyze their previous play statistics. In another embodiment date and method of display is utilized to determine player rankings for a given game and/or over a given time period

17. Ability to view available tables and register for live tables and/or tournaments via a remote connection such as the internet or an automated voice response unit.

18. Options adjust speed of play (speed of card shuffling, dealing, discarding, betting, etc etc)

19. Electronically transfer money from an account to the table

20. Electronically transfer money to another

21. Use of “cash card” to bring money to the table.

22. Ability for operator to view details of any and all tables

23. Ability for operator to view details of any and all players

In one aspect of the present invention, remote or virtual games may be provided by the system 10. The remote or virtual games may be provided on wireless devices and may be played at predetermined locations.

Virtual games may also be provided through the EPIAs 24. For example, the virtual or remote games may be played by the poker players when it is not their turn. The virtual or remote games may be another poker hand, played against other players, at the table or at other tables, or played against virtual players. Alternatively, the remote or virtual games may be other types of games, including, but not limited to blackjack, keno, slot machines, etc.

In addition to running other casino games on EPIA 24 or other terminals, system can be run on other gaming devices throughout the casino. For example, a virtual poker game can be run on an existing electronic bingo terminal or an electronic race book terminal.

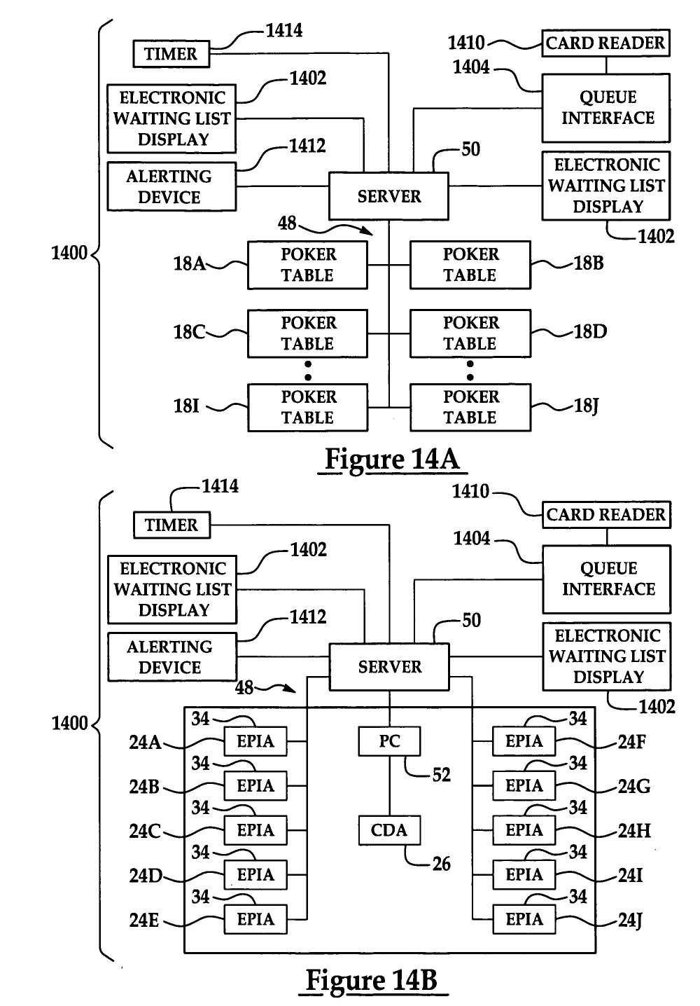

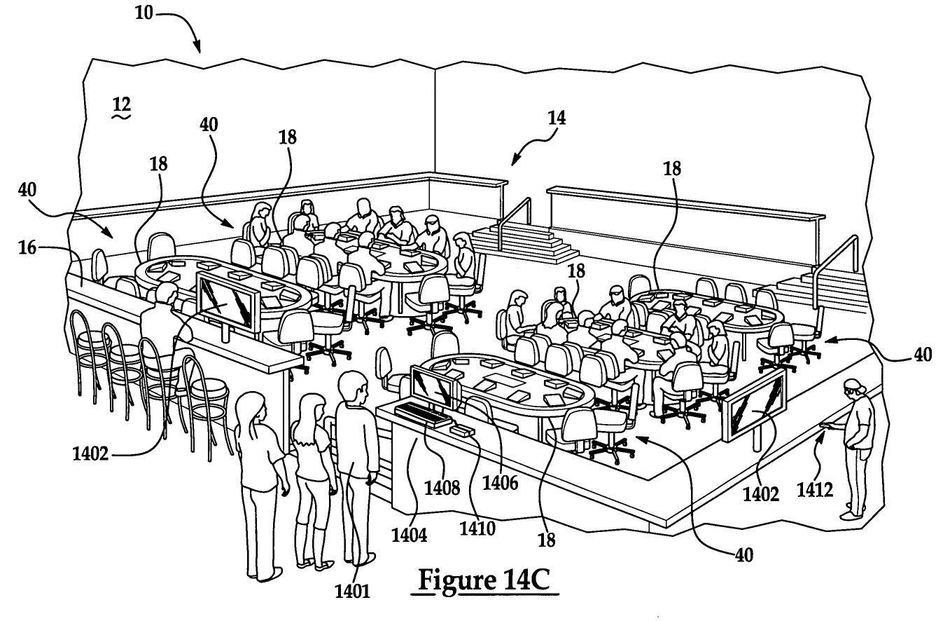

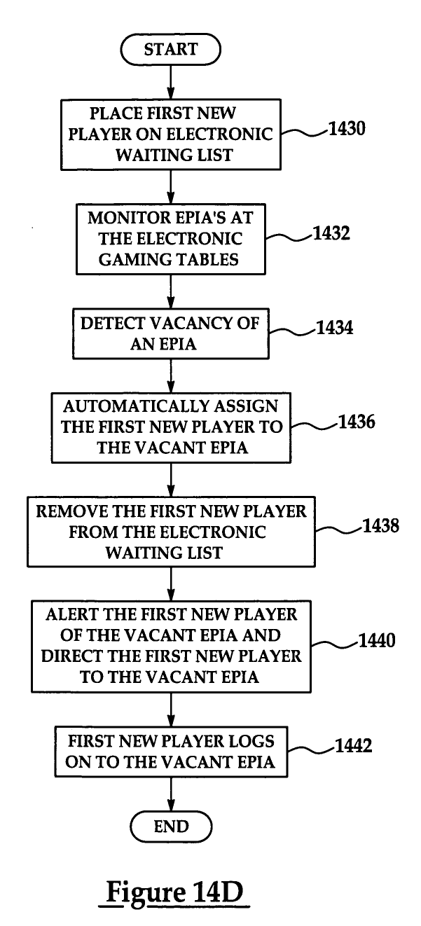

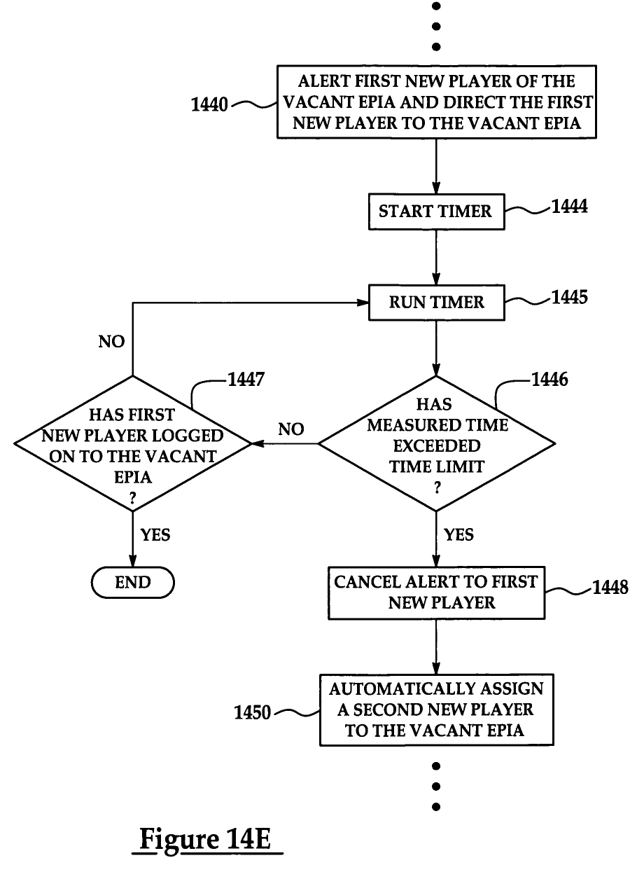

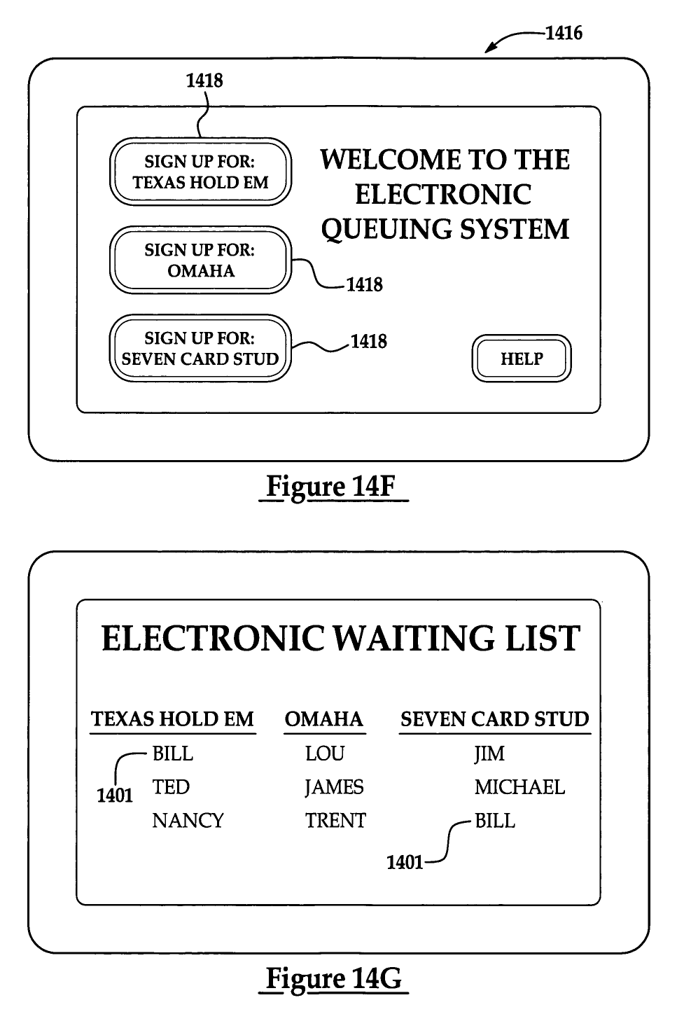

Referring to FIGS. 14A and 14B, a queuing system 1400 is provided to fill vacancies at the electronic poker tables 18A-18J in the poker room 14 by establishing an electronic waiting list. As previously described, the poker room 14 preferably includes multiple electronic poker tables 18A-18J adapted for accommodating different electronic poker game types, e.g., Texas Hold'Em, Omaha, Seven Card Stud, with different betting provisions, e.g., no limit, pot limit, 2/4, 10/20, etc. The queuing system 1400 may be adapted to establish electronic waiting lists for each of the electronic poker game types provided. In the embodiment shown, ten EPIAs 24A-24J are included at each of the electronic poker tables 18A-18J. The EPIAs 24A-24J form part of the queuing system 1400.

The queuing system 1400 includes a queue interface 1404. In FIG. 14C, the queue interface 1404 is shown as a computer with monitor 1404, keyboard 1408, and card reader 1410, for placing a first new player 1401 on the electronic waiting list. In this embodiment, the card reader 1410 is used to read an identification (ID) card such as a player tracking card, account card, or the like, of the first new player 1401. Likewise, the queue interface 1404 is used for processing a personal identification number (PIN) of the first new player 1401 in conjunction with reading the ID card. Other input devices known for identifying individuals could also be used, such as biometric scanners or radio frequency identification (RFID) devices. In further embodiments, the queue interface 1404 comprises a touch-screen kiosk, a web-based registration system, or telephone registration system, for placing the first new player 1401 on the electronic waiting list. Multiple display devices 1402 may be used to display the electronic waiting lists. For example, a large display device may be displayed remotely.

Referring back to FIG. 14B, the server computer 30 is connected to the plurality of EPIAs 24A-24J and the queue interface 1404. The server computer 30 is programmed to electronically monitor the plurality of EPIAs 24A-24J, electronically detect a vacancy at one of the plurality of EPIAs 24A-24J, and automatically and electronically assign the first new player 1401 to the vacant EPIA 24A-24J upon detect the vacancy. In one embodiment, each of the plurality of EPIAs 24A-24J includes a computer 34 networked to the server computer 30. The server computer 30 is programmed to detect the vacant EPIA 24A-24J by receiving an electronic signal transmitted by the computer 34 of the vacant EPIA 24A-24J to the server computer 30. The electronic signal may be, for example, generated when a player logs off their EPIA 24A-24J.

An alerting device 1412 is used to alert the first new player 1401 of the vacancy. The alerting device 1412 may comprise a display, a loudspeaker, a human host, a buzzer, or any combination thereof. In FIGS. 14A and 14B, the alerting device 1412 is in electronic communication with the server computer 30. In this instance, the alerting device 1412 may comprise a display that automatically displays a name or ID number of the first new player 1401, or the alerting device 1412 may be a buzzer electronically linked (preferably wireless) to the server computer 30 with the buzzer vibrating or buzzing upon the server computer 30 detecting the vacancy and assigning the vacant EPIA 24A-24J to the first new player 1401.

Still referring to FIGS. 14A and 14B, a timer 1414 may be used to measure a time period that starts upon alerting the first new player 1401 of the vacancy. In this instance, the first new player 1401 has a time limit in which to logon to the vacant EPIA 24A-24J after being alerted of the vacancy. If the first new player 1401 does not logon within the time limit, the server computer 30 is programmed to re-assign the vacant EPIA 24A-24J to a second new player on the electronic waiting list.

The server computer 30 may be programmed to monitor a plurality of electronic game types and the queue interface 1404 may be adapted to place a plurality of new players on an electronic waiting list for each of the plurality of electronic game types. Multiple game types may be played in the same location, e.g., the poker room 14, or separate locations may be utilized for each game type. In any event, the queuing system 1400 may be capable of placing multiple new players on the electronic waiting lists for each of the game types. In FIG. 14C, the poker room 14 is shown with five electronic poker tables 18 with only two of the electronic poker tables 18 being utilized for gaming.

With reference to FIGS. 14D and 14E, the method of operation and use of the queuing system 1400 will now be described with respect to the first new player 1401. Initially, the poker room 14 is filled to capacity with current players. Each of the current players is required to logon to their respective EPIA 24A-24J using the player interface 54. In effect, the current players logon to the network thereby transmitting an electronic signal to the server computer 30 that indicates that their EPIA 24A-24J is occupied. By requiring each of the current players to logon in some capacity, the server computer 30 electronically monitors which EPIAs 24A-24J are occupied and which are vacant.

With each of the EPIAs 24A-24J being occupied by one of the current players, the first new player 1401 is placed on the electronic waiting list in STEP 1430. As discussed, this may be accomplished a number of ways, e.g., ID card reader 1410/entering PIN, biometric scanner, touch-screen kiosk, web-based registration, telephone, and the like. An example of the touch-screen kiosk is shown in FIG. 14G, in which the touch screen 1416 includes touch-selectable buttons 1418 for accessing three different electronic waiting lists. One for Texan Hold'Em, one for Omaha, and one for Seven Card Stud. When any of these buttons 1418 are selected, the first new player 1401 is prompted to enter the information needed to place their name on the respective electronic waiting list. They may simply be prompted to pass their ID card through the card reader 1410 and/or enter their PIN, they may be prompted to scan a biometric, or they may be prompted to simply enter their name.

Referring back to FIG. 14D, the queuing system 1400 then monitors the EPIAs 24A-24J in STEP 1432 to determine when one of the current players vacates their EPIA 24A-24J (or if vacant EPIAs 24A-24J already exist). Preferably, the vacancy is detected in STEP 1434 by the server computer 30 when one of the plurality of current players logs off of their respective EPIA 24A-24J using the player interface 54. This provides the vacant EPIA 24A-24J for the first new player 1401. Essentially, the step of detecting the vacancy comprises the step of detecting the logoff. Once the logoff is detected, another electronic signal corresponding to the vacancy is transmitted to the server computer 30 from the computer of the vacant EPIA 24A-24J.

When this electronic signal is received by the server computer 30, the first new player 1401 is automatically assigned to the vacant EPIA 24A-24J in STEP 1436. Once the vacant EPIA 24A-24J is assigned, the first new player 1401 is removed from the electronic waiting list in STEP 1414 and then alerted of the vacancy in STEP 1440. As previously discussed, the alert may be in the form of a buzzer, a display, a loudspeaker, etc. Once located, the first new player 1401 will logon to the vacant EPIA 24A-24J in STEP 1442. Of course, if the time limit discussed above is in effect, the first new player 1401 will be required to logon to the vacant EPIA 24A-24J before the time limit expires. Otherwise, if the time limit expires, the queuing system 1400 will re-assign the vacant EPIA 24A-24J to the second new player. This sequence of events is best shown in FIG. 14E. Referring to FIG. 14E, the timer 1414 begins and runs in STEPS 1444 and 1445 after alerting the first new player 1401 of the vacancy. In STEP 1446, the measured time is compared to the time limit, while simultaneously, in STEP 1447, the server computer 30 continuously monitors if the first new player 1401 has logged on to the vacant EPIA 24A-24J. If the time limit is exceeded, the alert to the first new player 1401 is canceled in STEP 1448, and the second new player is assigned to the vacant EPIA 24A-24J in STEP 1450. In other embodiments, the time limit is measured between assigning the vacant EPIA 24A-24J and the first new player 1401 logging on to the vacant EPIA 24A-24J.

Referring to FIGS. 14F and 14G, the first new player 1401 may be placed on a plurality of electronic waiting lists corresponding to a plurality of electronic game types. Here, the queuing system 1400 is adapted to recognize that the first new player 1401 is listed on multiple electronic waiting lists, and the first new player 1401 is removed from each of the plurality of electronic waiting lists after automatically assigning the first new player 1401 to the vacant EPIA 24A-24J. Referring specifically to FIG. 14G, the display devices 1402 can also be adapted to display each of the plurality of electronic waiting lists.

In a further embodiment of the queuing system 1400, the first new player 1401 may be a current player that is already logged on at one of the EPIAs 24A-24J. In this instance, each of the EPIAs 24A-24J is configured with the queuing interface 1404 to allow current players to place themselves on electronic waiting lists for other game types while playing.

In a still further embodiment of the queuing system 1400, current players are also given a preference to vacated EPIAs 24A-24J at their current electronic poker table 18A-18J. One of the current players may exercise this preference by requesting a new EPIA 24A-24J at their electronic poker table 18A-18J through an option (not shown) displayed on their EPIA 24A-24J. If the option is selected, when the server computer 30 detects a vacant EPIA 24A-24J at their electronic poker table 18A-18J, the current player is given a predetermined time limit, e.g., 60 seconds, in which to accept the vacant EPIA 24A-24J at their electronic poker table 18A-18J. After the 60 second delay, the vacant EPIA 24A-24J is automatically assigned to the first new player 1401 on the electronic waiting list in accordance with the method set forth above.

In another embodiment of the present invention, the queue interface allows a user, such as an employee of the casino to bypass the electronic waiting list and assign another player to the vacant electronic player interaction area. The another player may be a preferred player, a VIP, a player who has a reservation, or other similar player.

Obviously, many modifications and variations of the present invention are possible in light of the above teachings. The invention may be practiced otherwise than as specifically described within the scope of the appended claims.

1. A method of filling a vacancy at an electronic gaming table with a first new player by establishing an electronic waiting list, said method comprising the steps of:
placing the first new player on the electronic waiting list;
monitoring a plurality of electronic player interaction areas at a plurality of electronic gaming tables;
detecting a vacancy of one of the plurality of electronic player interaction areas while monitoring the plurality of electronic player interaction areas; and
automatically assigning the first new player placed on the electronic waiting list to the vacant electronic player interaction area in response to detecting the vacancy.

2. A method, as set forth in claim 1, including the step of transmitting an electronic signal corresponding to the vacancy to a network having a server computer in response to detecting the vacancy.

3. A method, as set forth in claim 2, including the step of administering an electronic game at each of the plurality of electronic gaming tables.

4. A method, as set forth in claim 3, wherein the step of administering the electronic game further comprises the step of administering an electronic card game at each of the plurality of electronic gaming tables using electronic cards and electronic chips.

5. A method, as set forth in claim 3, including the step of providing a player interface at each of the plurality of electronic player interaction areas to allow each of a plurality of current players to logon to the plurality of electronic player interaction areas and play the electronic game.

6. A method, as set forth in claim 5, including the step of providing a computer for each of the plurality of electronic player interaction areas to provide the player interface.

7. A method, as set forth in claim 6, wherein the step of monitoring the plurality of electronic player interaction areas further comprises the step of electronically monitoring the logging on of each of the plurality of current players to the plurality of electronic player interaction areas.

8. A method, as set forth in claim 7, including the step of allowing one of the plurality of current players to logoff of their respective electronic player interaction area using the player interface thereby providing the vacant electronic player interaction area.

9. A method, as set forth in claim 8, wherein the step of detecting the vacancy further comprises the step of detecting the logoff.

10. A method, as set forth in claim 9, wherein the step of transmitting the electronic signal further comprises the step of transmitting the electronic signal from the computer of the vacant electronic player interaction area to the server computer.

11. A method, as set forth in claim 1, including the step of alerting the first new player of the vacancy.

12. A method, as set forth in claim 11, including the step of allowing the first new player to logon to the vacant electronic player interaction area.

13. A method, as set forth in claim 12, including the step of establishing a time limit between alerting the first new player of the vacancy and the first new player logging on to the vacant electronic player interaction area.

14. A method, as set forth in claim 13, including the step of re-assigning the vacant electronic player interaction area to a second new player if the first new player does not logon to the vacant electronic player interaction area within the established time limit.

15. A method, as set forth in claim 14, including the step of removing the first new player from the electronic waiting list if the established time limit is exceeded.

16. A method, as set forth in claim 1, including the step of removing the first new player from the electronic waiting list upon automatically assigning the first new player to the vacant electronic player interaction area.

17. A method, as set forth in claim 1, wherein the step of placing the first new player on the electronic waiting list further comprises the step of reading an identification card of the first new player and processing a personal identification number (PIN) of the first new player.

18. A method, as set forth in claim 1, wherein the step of placing the first new player on the electronic waiting list further comprises the step of entering an identifier and a personal identification number (PIN) into a computer terminal.

19. A method, as set forth in claim 1, wherein the step of placing the first new player on the electronic waiting list further comprises the step of placing the first new player of the electronic waiting list using a web-based registration system.

20. A method, as set forth in claim 1, wherein the step of placing the first new player on the electronic waiting list is further defined as placing the first new player on one of a plurality of electronic waiting lists corresponding to one of a plurality of electronic game types.

21. A method, as set forth in claim 20, including the step of placing the first new player on each of the plurality of electronic waiting lists corresponding to each of the plurality of electronic game types.

22. A method, as set forth in claim 21, including the step of removing the first new player from each of the plurality of electronic waiting lists after automatically assigning the first new player to the vacant electronic player interaction area.

23. A method, as set forth in claim 21, including the step of displaying each of the plurality of electronic waiting lists on a plurality of display devices.

24. A method, as set forth in claim 1, wherein the step of placing the first new player on the electronic waiting list further comprises the step of allowing the first new player to place themselves on the electronic waiting list at one of the plurality of electronic player interaction areas while the first new player is playing at one of the plurality of electronic gaming tables.

25. A method, as set forth in claim 1, wherein the step of automatically assigning the first new player to the vacant electronic player interaction area further comprises the step of providing a preference to a current player that requests the vacant electronic player interaction area while playing at another electronic player interaction area at the same electronic gaming table as the vacant electronic player interaction area.

26. A method, as set forth in claim 1, including the step of allowing a user to bypass the electronic waiting list and assign another player to the vacant electronic player interaction area.

27. A system for filling a vacancy at an electronic gaming table with a first new player by establishing an electronic waiting list, said system comprising:
a plurality of electronic player interaction areas for use by a plurality of current players;
a queue interface for placing the first new player on the electronic waiting list;
a network including a server computer networked to the plurality of electronic player interaction areas and the queue interface and programmed for monitoring the plurality of electronic player interaction areas, detecting a vacancy at one of the plurality of electronic player interaction areas, and automatically assigning the first new player to the vacant electronic player interaction area in response to detecting the vacancy.

28. A system, as set forth in claim 27, including a plurality of electronic gaming tables with the plurality of electronic player interaction areas being located at the plurality of electronic gaming tables.

29. A system, as set forth in claim 28, wherein each of the plurality of electronic gaming tables comprises a central display area and a playing surface with the electronic player interaction areas being located about a periphery of the electronic gaming table wherein each of the plurality of electronic player interaction areas provides a player interface for interaction with each of the current players, the central display area being located in a central location of the electronic gaming table for displaying information to the current players.

30. A system, as set forth in claim 28, wherein the server computer is programmed for administering an electronic card game at each of the plurality of electronic gaming tables using electronic cards and electronic chips.

31. A system, as set forth in claim 30, wherein each of the plurality of electronic player interaction areas includes a computer and the server computer is programmed to detect the vacancy by receiving an electronic signal transmitted by the computer of the vacant electronic player interaction area.

32. A system, as set forth in claim 27, including an alerting device for alerting the first new player of the vacancy.

33. A system, as set forth in claim 32, wherein the alerting device comprises a display, a loudspeaker, a human host, a buzzer, or any combination thereof.

34. A system, as set forth in claim 32, including a timer for measuring a time period starting upon alerting the first new player of the vacancy whereby the first new player has a time limit from being alerted of the vacancy to logon to the vacant electronic player interaction area and the server computer is programmed to re-assign the vacant electronic player interaction area to a second new player on the electronic waiting list if the time limit is exceeded.

35. A system, as set forth in claim 27, wherein the queue interface comprises a reader for reading an identification card of the first new player and a computer for processing a personal identification number (PIN) of the first new player.

36. A system, as set forth in claim 27, wherein the queue interface comprises a computer terminal with an input device.

37. A system, as set forth in claim 27, wherein the queue interface comprises a web-based registration system.

38. A system, as set forth in claim 27, wherein the server computer is programmed for monitoring a plurality of electronic game types and the queue interface is adapted for placing a plurality of new players on an electronic waiting list for each of the plurality of electronic game types.

39. A system, as set forth in claim 27, including at least one display device for displaying the electronic waiting list for each of the plurality of electronic game types.

40. A system, as set forth in claim 27, the queue interface for allowing a user to bypass the electronic waiting list and assign another player to the vacant electronic player interaction area.
